(19) United States
(12) Patent Application Publication
(10) Pub. No.: US 2021/0201385 A1
(43) Pub. Date: Jul. 1, 2021

(54) DISPLAY DEVICE, MOBILE TERMINAL, CONTROL METHOD, STORAGE MEDIUM, AND GUIDE SYSTEM

(71) Applicant: Fast Retailing Co., Ltd., Yamaguchi-Shi (JP)

(72) Inventors: Jun Hirata, Yamaguchi (JP); Tong Liu, Yamaguchi (JP)

(73) Assignee: Fast Retailing Co., Ltd., Yamaguchi-Shi (JP)

(21) Appl. No.: 17/132,636

(22) Filed: Dec. 23, 2020

(30) Foreign Application Priority Data
Dec. 26, 2019 (JP) 2019-237040

(51) Int. Cl. G06Q 30/06; H04W 4/80; H04W 4/35; H04W 4/02; G06Q 10/08

(52) U.S. Cl. CPC G06Q 30/0639; H04W 4/80; G06Q 30/0643; H04W 4/025; G06Q 10/087; H04W 4/35

(57) ABSTRACT

A display device that displays position information of a product on the basis of identification information of each product and position information of a tag from which the identification information has been read. The display device includes: an acceptance unit that accepts designation of a product from a user; an acquisition unit that acquires position information associated with identification information of the product, designation of which by the user has been accepted by the acceptance unit, and scan time information indicating time when a tag as a basis of the position information has been read; and a display control unit that identifiably displays a floor map and a position corresponding to the position information acquired by the acquisition unit on the floor map by designation from the user. The display control unit makes display forms of the position information different depending on the scan time information.

### BACKGROUND

In clothing stores and the like, various clothing items are displayed as products in stores. Compared to products in other fields, clothing has a shorter cycle, and products in demand vary depending on the weather, and thus it is necessary to frequently change the layout in stores. For this reason, it is difficult for a consumer to find a desired product in a store, and there are cases where even a clerk has difficulty in grasping the display positions of products.

JP 2011-198188 A discloses an article retrieval system in which the position of a retrieval object article is displayed on a display unit by inputting the name of the retrieval object article to a retrieval device. Meanwhile, JP 2007-316897 A discloses technology for guiding a user to the position of a specific product by acquiring position information of each product in advance by RFID scanning and also position information of the user who is operating a smartphone.

### SUMMARY

According to some embodiments of the present invention, in a display device that displays position information of a product on a basis of identification information of the product, the identification information being information of each product, and position information of a tag from which the identification information has been read, designation of a product by a user is accepted, and position information that is associated with identification information of the product, designation of which by the user has been accepted, and scan time information, indicating time when a tag as a basis of the position information has been read, are acquired. A floor map and a position corresponding to the position information on the floor map are displayed in an identifiable manner in accordance with designation from the user. At this point, display forms of the position information are made different depending on the scan time information.

Further features of the present disclosure will become apparent from the following description of exemplary embodiments (with reference to the attached drawings).

### BRIEF DESCRIPTION OF THE DRAWINGS

FIG. 1 is a schematic diagram illustrating the configuration of a guide system including a display device;

FIG. 2 is a block diagram illustrating the hardware configuration of the display device;

FIG. 3A is a configuration diagram illustrating the configuration of a reading device; FIG. 3B is a flow chart illustrating an output process of identification information in the reading device;

FIG. 4 is a flow chart illustrating an example of processing in a server;

FIG. 5 is a flow chart illustrating an example of processing in the display device;

FIG. 6A is a schematic diagram illustrating an example of a product designation screen displayed on a display; FIG. 6B is a schematic diagram illustrating an example of an advertisement screen displayed on a terminal owned by a user;

FIG. 7A is a schematic view illustrating an example of a floor map illustrating product positions; FIG. 7B is a schematic view illustrating an example of a product details screen; FIG. 7C is a schematic view illustrating an example of a floor map including inventory information of a selected product;

FIG. 8A is a schematic view illustrating a usage state of a transmitter according to a second embodiment; FIG. 8B is a schematic diagram illustrating the configuration of a guide system including the transmitter; and

FIG. 9 is a flow chart illustrating an example of processing in the transmitter;

FIG. 10 is a schematic view illustrating how RFID tags for a fixture are arranged; and

FIGS. 11A to 11C are schematic diagrams illustrating how new and old read position information of a product is displayed.

### DESCRIPTION OF THE EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### First Embodiment

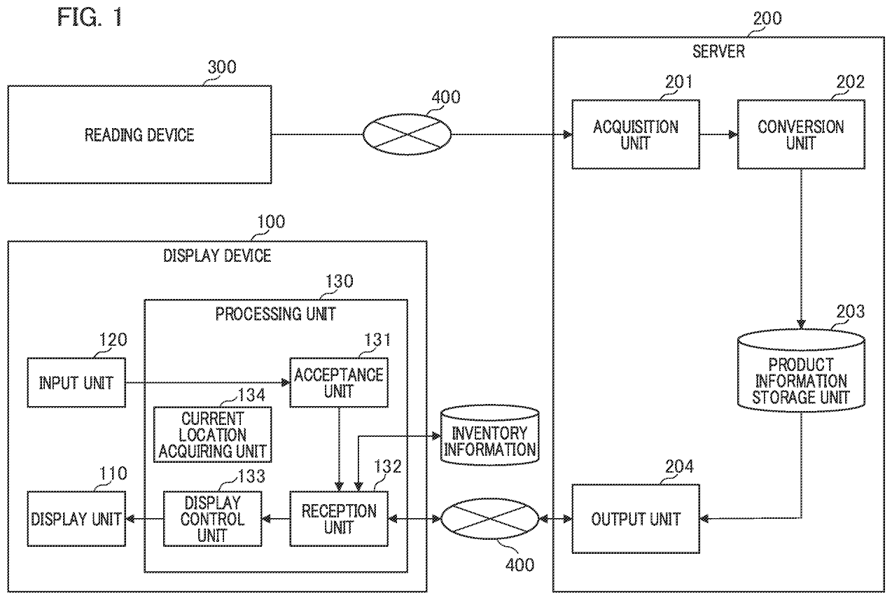

FIG. 1 is a schematic diagram illustrating the configuration of a guide system 1000 including a display device 100. The guide system 1000 includes the display device 100, a server 200, and a reading device 300. These devices are communicably connected by a network 400. The network 400 includes, for example, a wireless base station, a provider device, and a dedicated line of, for example, the Internet, a wide area network (WAN), a local area network (LAN), or WiFi. The guide system 1000 is a system that guides a user to a product position by acquiring product positions by scanning tags attached to each of products in a store by the reading device 300 and causing the display device 100 to display the position information corresponding to the product designated by the user.

The display device 100 is, for example, a display (signage device) installed in or outside a clothing store, a smartphone, a tablet terminal, a laptop personal computer (PC), a desktop PC, a mobile phone, or the like. Note that, in the present specification, the term “mobile terminal” refers to an information processing device that can be carried by a user such as a smartphone, a tablet terminal, a laptop PC, or a mobile phone. The display device 100 includes a display unit 110, an input unit 120, and a processing unit 130.

The display unit 110 is, for example, a liquid crystal display panel, a plasma display panel, or an organic EL display panel and is controlled by the processing unit 130. The display unit 110 displays an image under the control of the processing unit 130.

The input unit 120 is, for example, a touch panel, a keyboard, or a mouse that receives operation input from a user and receives an instructions or input from the user by the touch panel or the keys. Note that the input unit 120 may also function as the display unit 110 and that the display unit 110 and the input unit 120 may be integrated in cases such as that the display device 100 is a signage device, a smartphone, or the like. For example, the user designates a product using the input unit 120.

The processing unit 130 includes an acceptance unit 131, a reception unit 132, a display control unit 133, and a current location acquiring unit 134. The acceptance unit 131 accepts designation of a product from a user. The reception unit 132 receives, from the server 200, position information associated with identification information of a product designated by a user by the acceptance unit 131. In addition, inventory information of the designated product in a target shop is received from, for example, a database for managing the product inventory at each store. The display control unit 133 causes the display unit 110 to display a floor map in accordance with designation from the user. The display control unit 133 also causes a point corresponding to the position information received by the reception unit 132 to be displayed on the floor map in an identifiable manner. The current location acquiring unit 134 acquires the current location of the display device 100. Note that, for example in a case where the display device 100 is a fixed type, the current location acquiring unit 134 may not be included as long as the processing unit 130 has information of the position where the display device is installed.

For example in a case where a tag supports RFID, the tag includes an antenna and a chip for storing identification information inside the tag and is attached to a package or fixed to a part of the product with a member called LOX. When a radio wave of a UHF band reader and writer is received from the outside by the antenna in the tag, an electric wave is generated, and the information held in an IC is output to the outside by a similar UHF band radio wave. The server 200 includes an acquisition unit 201, a conversion unit 202, a product information storage unit 203, and an output unit 204. The acquisition unit 201 acquires identification information of each of products read from tags attached to the products and position information of the tags by the reading device 300. Here, note that identification information of products includes at least color information and size information of products. Of course, the size and color may be replaced with corresponding information (numbers such as numerical values). For example, “S, M, L” may be replaced with “1, 2, 3”, respectively, or colors of “white, black, yellow” may be replaced with “00, 09, 45”, respectively, for example. Meanwhile, the tags are capable of recording identification information of products, such as RFID tags. For example in a case where a tag supports RFID, the tag includes an antenna and a chip for storing identification information inside the tag and is attached to a package or fixed to a part of the product with a member called LOX. When a radio wave of a UHF band reader and writer is received from the outside by the antenna in the tag, an electric wave is generated, and the information held in an IC is output to the outside by a similar UHF band radio wave. The conversion unit 202 converts the identification information acquired by the acquisition unit 201 and the position information of the tag into position information (display position information) to be reflected on the floor map of the store. The product information storage unit 203 stores the display position information converted by the conversion unit 202 in association with the identification information. Here, the product information storage unit 203 may further store the display position information in association with floor identification information for identifying which floor of which store. The output unit 204 outputs position information corresponding to identification information of a product designated by the user in the display device 100 to the display device 100. Note that as for displays installed inside and outside the store, floor identification information suitable for the displays may be set in advance. In that case, the display device 100 outputs both the set floor identification information and identification information of a product designated by the user to the server 200 and acquires display position information of the desired product in the store from the server 200.

The reading device 300 acquires identification information of products from the tags attached to the products displayed in the store. The reading device 300 also estimates the positions of the products for which the identification information has been acquired (practically, the position of the tags attached to the product) and outputs the positions to the server 200 together with the identification information. The reading device 300 is, for example, an antenna installed on the ceiling of a store or a portable reading terminal.

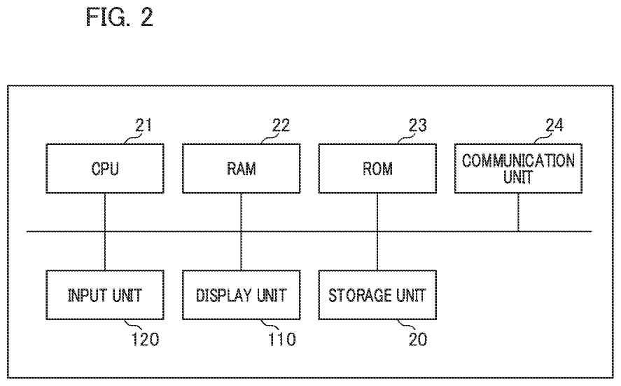

FIG. 2 is a block diagram illustrating the hardware configuration of the display device 100. The display device 100 includes a storage unit 20, a CPU 21, a RAM 22, a ROM 23, a communication unit 24, a display unit 110, and an input unit 120.

The storage unit 20 stores, for example, a program that implements a flow described later by being executed by the CPU 21 and data used by this program.

The CPU 21 operates based on a program stored in the ROM 23 or the storage unit 20 and controls the units of the display device 100. The ROM 23 stores, for example, a boot program executed by the CPU 21 at the time of activation of the display device 100 or a program dependent on the hardware of the display device 100. The CPU 21 expands the program in the ROM 23 on the RAM 22, and the CPU 21 executes the expanded program to implement the flow which will be described later. Note that the CPU 21 may acquire these programs from another device via the network 400 and execute the programs or may directly execute the programs stored in the ROM 23.

The communication unit 24 receives data from another device via the network 400 and sends it to the CPU 21, and transmits the data or instructions generated by the CPU 21 to another device via the network 400. Note that the server 200, the reading device 300, and an inventory information database 500 each have a similar configuration to that in FIG. 2; however, detailed description thereof will be omitted.

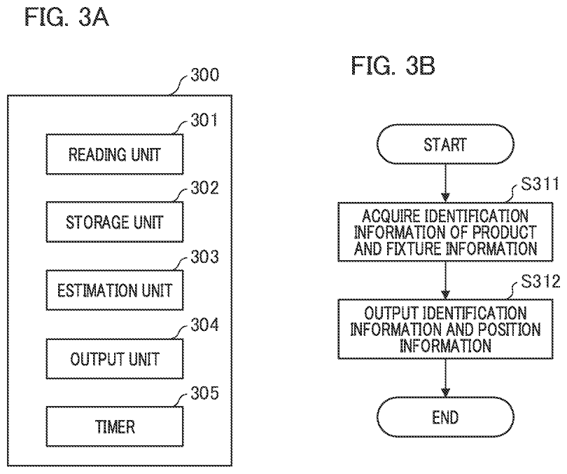

FIGS. 3A to 3C are diagrams for explaining the reading device 300. FIG. 3A is a configuration diagram illustrating the configuration of a reading device. Here, a case where the reading device 300 is a portable reading terminal will be described as an example. The reading device 300 includes a reading unit 301, a storage unit 302, an estimation unit 303, an output unit 304, and a timer 305. The reading unit 301 includes a plurality of antennas, reads identification information of a product from the tag of the product, and acquires relative position information indicating the position of the tag relative to the reading device 300 by the plurality of antennas. The reading unit 301 may include only one antenna although the reading resolution or accuracy is reduced. The reading unit 301 also reads identification information and relative position information of a fixture from tags arranged in each fixture installed in the store when reading the tags of the product. The identification information of the tags arranged in each fixture is associated with the position information of the fixture (absolute position in the store and on the floor map). The estimation unit 303 compares the relative position information of a read tag of each product with the relative position information of the tags of the fixture and estimates which fixture each product belongs to. Alternatively, the estimation unit 303 may estimate the absolute position of each product from the absolute position set on the tags of a fixture and the relative position of the tags of the fixture and the relative position of each product. The storage unit 302 stores read identification information of products and identification information of a fixture to which each product belongs (displayed) in association with each other. Note that, at this point, the storage unit 302 acquires, from the timer 305, time (scan time) when the identification information of each product has been read and stores it as an addition method (metadata) of the identification information of each product. The timer 305 clocks with an internal counter and holds the date and time. It is desirable that the output unit 304 outputs identification information of a product and identification information of at least one or more fixtures to the server 200 in association with each other. Here, the output unit 304 may output also the absolute position of each product to the server 200 in a case where the estimation unit 303 estimates the absolute position of the tag read from a product, and in a case where the absolute position is not estimated, the output unit 304 may output the relative position of each product. In a case where the storage unit 302 stores time when the identification information of products has been read, this is also output.

FIG. 3B is a flow chart illustrating an output process of identification information in the reading device. In S311, a user carries the reading device 300 and travels in the store. As a result, the reading unit 301 acquires identification information from the tags of products displayed in the store and simultaneously acquires identification information of fixtures in which the products are displayed. Then, the read identification information of the products and the identification information of the fixtures are stored in the storage unit 302 in association with each other. Next, in S312, the output unit 304 outputs the identification information of the products and the identification information of the fixtures to the server 200 in association with each other.

Note that, in the guide system 1000, scans in accordance with the flow of FIG. 3B using the reading device 300 may be performed periodically or irregularly. However, in a case where a full scan of scanning the most part of the floors of the store is performed on a regular basis at a first frequency (for example, once a day before opening of the store), it is preferable to perform a partial scan of scanning a narrower area than the full scan (part of the floors of the store) at a second frequency (for example, once around noon and once in the evening) which is more frequent than the full scan is. Note that the scans may be performed by a plurality of portable reading devices 300. Note that the reading device or the server is controlled to update to overwrite old position information with recently read position information when the same tag is read.

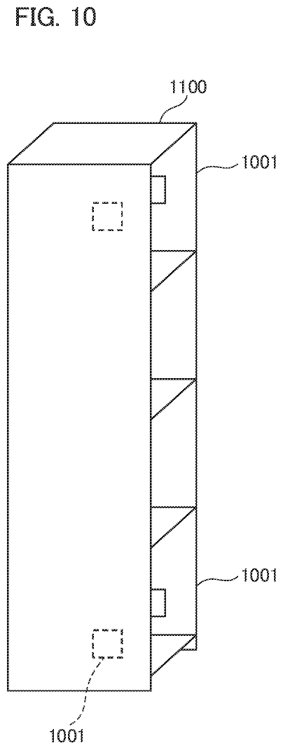

FIG. 10 illustrates how a plurality of RFID tags 1001 for a fixture is attached to a fixture 1100. Unless the shelf is sealed with a metal plate, it is preferable to arrange the RFID tags at places that is not noticeable from the outside. Regarding the RFID tags 1001, if the accuracy of a display position of a product may be low, the number of tags per fixture 1100 may be reduced. Conversely, if it is intended to improve the accuracy of the display position of a product, at where in a fixture 1100 a read RFID tag 1001 is arranged may be distinguished by increasing the number of tags per fixture 1100 (reduce the coverage per tag) and embedding different identification information in each tag.

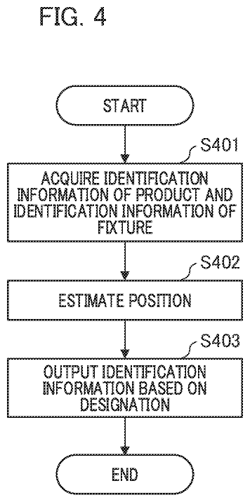

Next, a flow diagram for explaining the processing in the server 200 will be described. FIG. 4 is a flow chart illustrating an example of the processing in the server 200. First, in S401, the acquisition unit 201 acquires identification information of a product and identification information of a fixture associated with the identification information of the product from the reading device 300. At this point, it is desirable to also acquire the time when the identification information of the product has been read; however in a case where the identification information of the tag read by the reading device 300 is output to the server one by one, the server 200 may issue a time stamp at the time when the server 200 receives identification information, and the time stamp may be treated as the scan time described above. Next, in S402, the conversion unit 202 (which also functions as the estimation unit) estimates the position of the product in the store on the basis of the identification information of the product acquired by the acquisition unit 201 and the identification information of the fixture associated with the identification information of the product. Then, this position information is converted into information (display position information) that can be reflected on the floor map of the store, and the converted information is stored in the product information storage unit 203. Then in S403, the output unit 204 outputs the identification information of products with the position information of the products to the display device 100 in association with each other in accordance with the designation in the display device 100. Note that the server 200 retains layout information that indicates the outline of the layout in each store. The layout information includes the location of the store (including the country name and the store name), a store number, the store type, image data (pdf format or jpeg format) as a map that outlines the arrangement of walls or fixtures (racks) in the store or the position of pillars, and the position information and the orientation of the display device in the store. Then, in S403, the output unit 204 outputs maps corresponding to floors of the inquired store and related information (including the position and the orientation of the display device) to the display device 100.

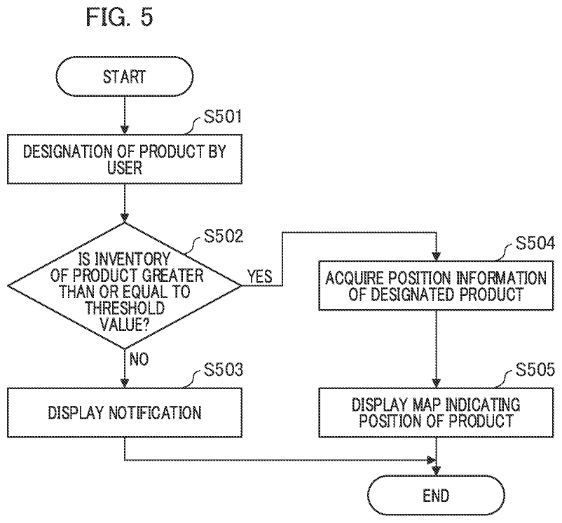

Next, a flow chart for explaining the processing in the display device 100 will be described. FIG. 5 is a flow chart illustrating an example of processing in the display device 100. In S501, a user designates a product. For example, a product may be designated from candidates displayed on the display device 100 using the input unit 120. Alternatively, for example in a case where the display device 100 is a smartphone and includes a camera, a product may be designated by photographing the tag of the product in the store with the camera. Moreover, a product may be designated by photographing a code such as a QR code (trademark) or a barcode displayed in an advertisement with a camera. Furthermore, designation may be performed by selecting, on a terminal owned by a user such as a smartphone, a product published in a message such as an advertisement transmitted to the terminal. In this case, for designating the color and size, the color and size published in the advertisement may be automatically designated, or the color and size may be designated after the user selects the product on the terminal. The acceptance unit 131 accepts the designation performed in this manner.

In S502, the reception unit 132 receives inventory information of products in the store from, for example, a database for managing products in the store. Note that the inventory information of products in the store may be stored in the server 200. In S502, if the number of stocks of the product are less than or equal to a threshold value (No), the display control unit 133 causes the display unit 110 to display a notification screen such as “please contact the staff” or “out of stock in the store”. On the other hand, if the number of stocks of the product are greater than or equal to the threshold value (Yes) in S502, the reception unit 132 receives position information associated with identification information of the designated product from the server 200. Then, the display control unit 133 displays the floor map on the display unit 110 and displays a portion on the floor map that corresponds to position information of the product received by the reception unit 132 in an identifiable manner. Note that, for example in a case where the display device 100 is a signage device in this case and the display device 100 has information related to the installation position of the display device 100 in the store, it is preferable to display the installation position of the display device 100 on the floor map in an identifiable manner. Displaying in this manner allows the user to grasp the current location, and it becomes easier to grasp the position of the products.

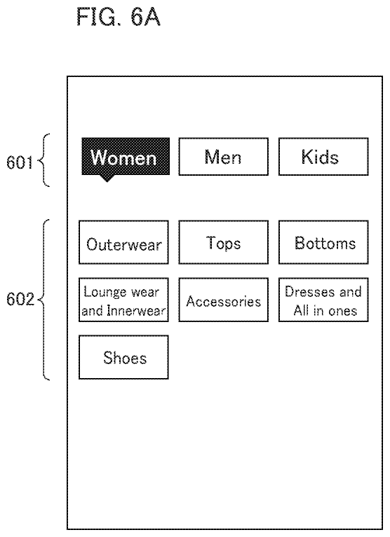

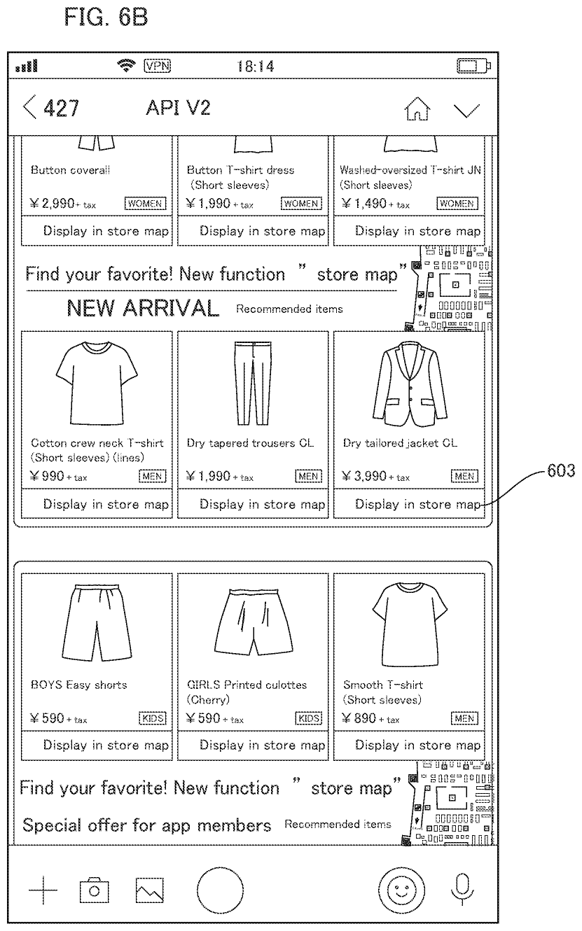

FIGS. 6A and 6B are schematic diagrams illustrating an example of a product designation screen. FIG. 6A is a schematic diagram illustrating an example of a product designation screen displayed on a display. Icons 601 are used to select a product category (major category) such as women's clothing (Women), men's clothing (Men), and children's clothing (Kids). This diagram illustrates an example in which women's clothing is selected. Icons 602 are used to select a specific category (middle category) under the category selected by the icon 601 such as outerwear, tops, bottoms, lounge wear and innerwear, accessories, dresses and all in ones, or shoes. When the user selects a desired category from the icons 602, a list of products corresponding to the category is displayed. Then, by selecting a desired product from the displayed list of products, the product is designated. Incidentally, after selecting the middle category, more specific categories (small categories) under the middle category may be further displayed. According to such a designation method of products, it is easy for the user to select a desired product.

FIG. 6B is a schematic diagram illustrating an example of an advertisement screen displayed on a terminal owned by a user. The user designates a product by selecting a product published in the advertisement on the terminal. When designating a product from the advertisement, the user can intuitively select the product. For example when the user taps a button 603 to display an in-store map (floor map), the position of the product in the store is displayed on the floor map in an identifiable manner on the basis of link information associated with the tapped button 603.

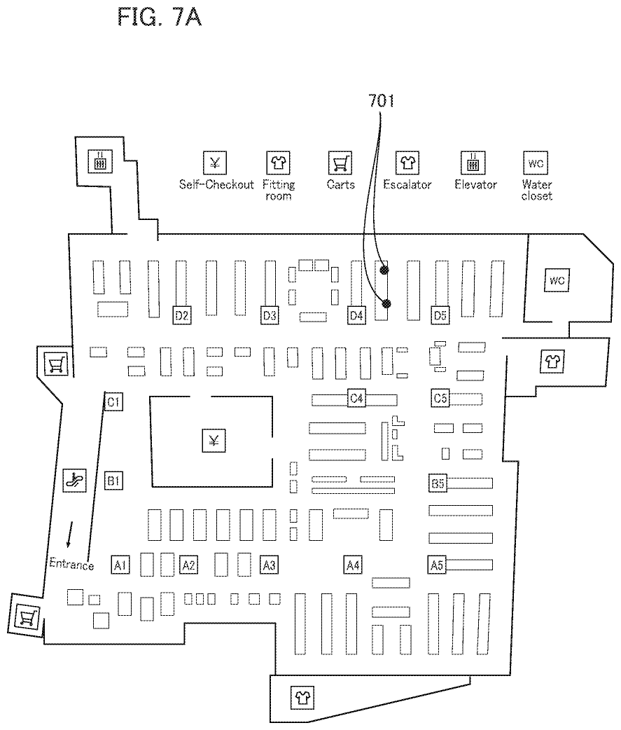

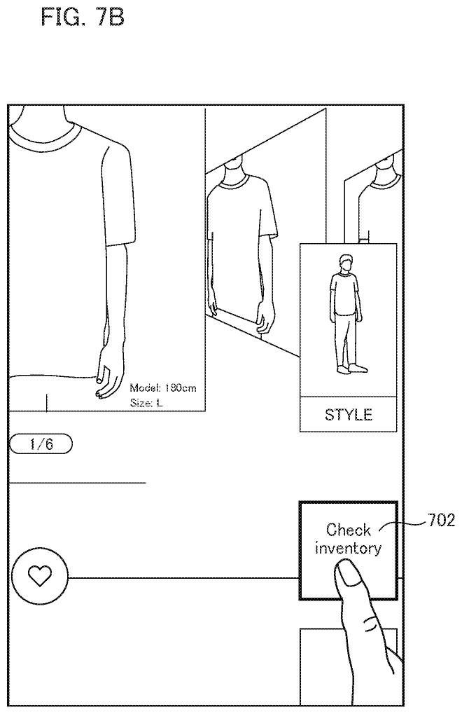

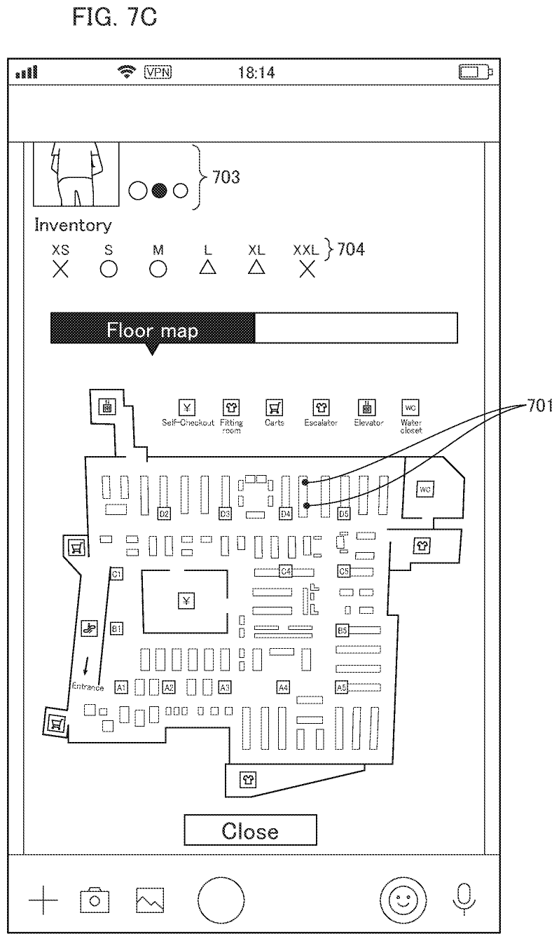

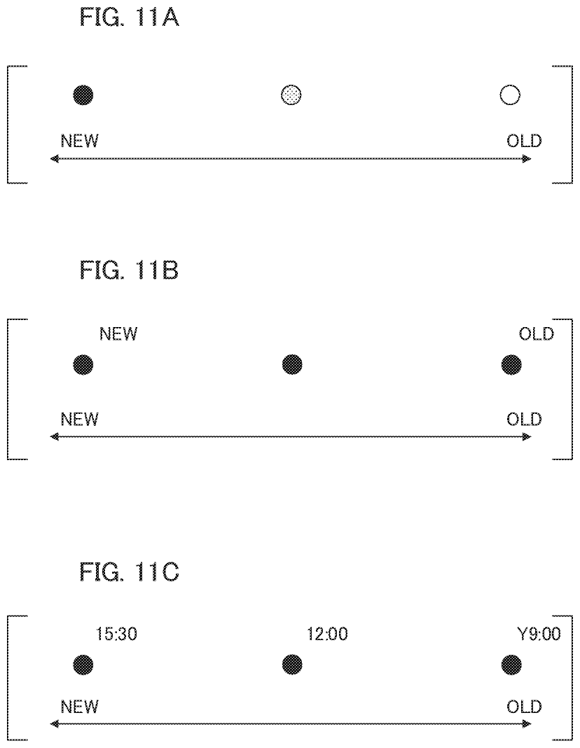

FIGS. 7A to 7C are schematic diagrams illustrating examples of display screens. FIG. 7A is a schematic view illustrating an example of a floor map illustrating product positions. In a case where the product designated by the user is in stock, the position of the designated product in the store is displayed on the floor map in an identifiable manner. In these diagrams, an icon 701 indicates the position of a designated product. It is preferable that the icon 701 is highlighted on the floor map by, for example, a highlighted color, a framed display, or blinking. Displaying the product position on the floor map in this manner allows the user to accurately and smoothly find the desired product. Here, the display device 100 makes display forms of the icon 701 different depending on how recent the time when the tag as a basis of the position information has been scanned. For example, as illustrated in FIG. 11A, as the time when position information has been read is more recent, the icon is made more conspicuous by changing the contrast or color. Alternatively, as illustrated in FIG. 11B, position information which has been read recently may be displayed with, for example, “NEW” so that it is understood that it is new at a glance, while contrary position information may be displayed with, for example, “OLD” so that it is understood that it is old. Alternatively, as illustrated in FIG. 11C, the time when the position information has been read may be displayed as it is. Incidentally, “Y9:00” indicates that it has been read at 9:00 a.m. of the preceding day.

FIG. 7B is a schematic view illustrating an example of a product details screen. For example, when a product is selected, a screen illustrating the details of the product may be displayed after the product is selected. The product details screen contains, for example, information of available sizes and colors of the selected product. In addition, an icon 702 for checking the inventory is displayed on the product details screen. For example, the user taps the icon 702 to display a floor map containing inventory information of the designated product.

FIG. 7C is a schematic view illustrating an example of a floor map including inventory information of a selected product. The floor map in this diagram also displays information of available sizes and colors of the selected product. In addition, the inventory status of each size is also displayed. The inventory status is displayed in such a manner as, for example, marked with × indicating that the product is out of stock when three or less articles are in stock, marked with Δ indicating that a few are in stock when four to five articles are in stock, and marked with ∘ indicating that there are enough articles in stock when six or more articles are in stock. Furthermore, in a case where a floor map is displayed as the one illustrated in this diagram, a user can specify the size and color on the screen after selecting a product. For example, when the user selects a desired color from the icon 703 indicating color information, the inventory status of each size of the selected color and the product position are displayed on the screen. Meanwhile, a desired size may be selected from an icon 704 indicating size information without selecting the color. In this case, among the icons 703 indicating the color information, it is displayed to indicate that the product is out of stock for example by displaying diagonal lines for a color that is out of stock.

As described above, according to the present embodiment, a desired product can be accurately and smoothly found in a store such as a clothing store.

### Second Embodiment

In the present embodiment, a mode will be described in which a smartphone of a customer approaching a store is detected and notification is sent to the smartphone notifying that the display illustrated in FIG. 6B can be displayed. Note that the same symbol is given to a configuration or a process having the same function as that in the first embodiment, and description thereof will be omitted for those having the same configuration or function.

The first embodiment is pull-type technology, that is, a mechanism in which a message is delivered after a client makes a request to a server, whereas a second embodiment is push-type technology, which is a mechanism in which a preset server delivers a message to a client in accordance with a predetermined condition.

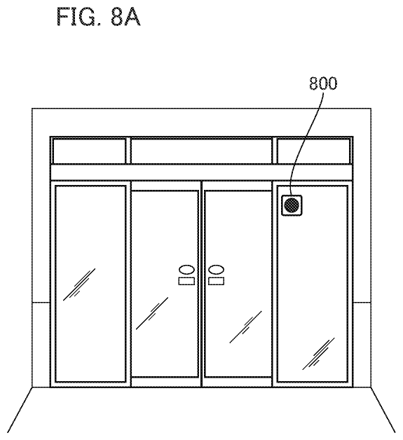

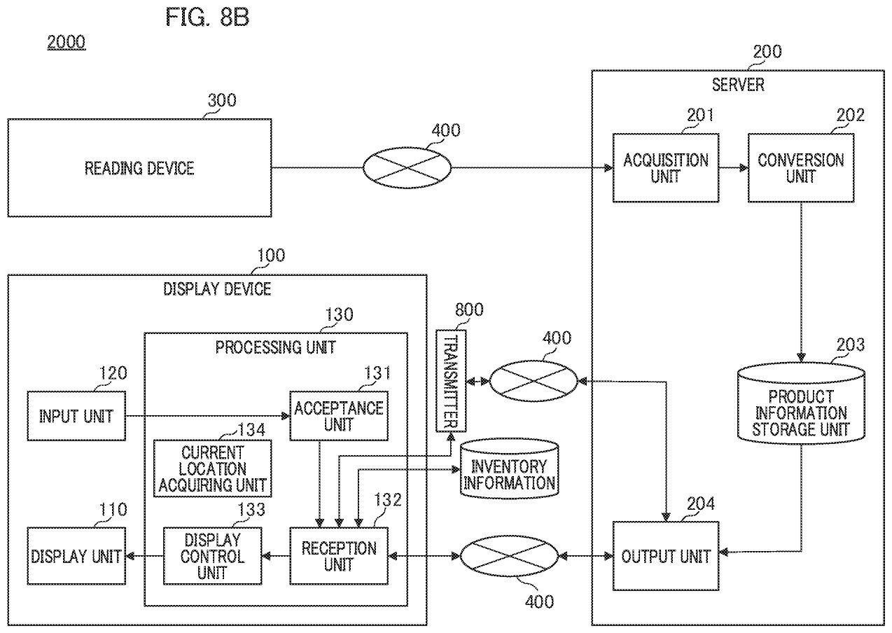

FIG. 8A is a schematic view illustrating a usage state of a transmitter 800 according to the second embodiment. As illustrated in FIG. 8A, the transmitter 800 (beacon) that functions as a device that transmits Bluetooth signals is installed at an entrance of a store. FIG. 8B is a schematic diagram illustrating the configuration of a guide system 2000 including the transmitter 800. The transmitter 800 may send a message directly to a smartphone, or the transmitter 800 may notify the server 200 that the smartphone is approaching, and the server 200 may deliver a message via the transmitter 800 when a user carrying a mobile terminal (display device 100), such as a smartphone that supports the Bluetooth (registered trademark) signal (search signal in this case) of the transmitter 800, approaches the entrance of the store. A reception unit 132 of the mobile terminal receives the message transmitted from the transmitter 800.

Note that the message here includes information for displaying the screens illustrated in FIGS. 6B and 7A. Specifically, included are thumbnails of product images illustrated in FIG. 6B, price information indicating their prices, link information of product position maps of respective products, and a product position map of each of the products. In this example, the product position maps (map illustrating the position of each product) of the respective products are embedded in the message in advance as images, and clicking a button 603 directly under a thumbnail of a product image in FIG. 6B results in displaying a product position map of a corresponding product as illustrated in FIG. 7A on the basis of link information associated with the button.

Note that the smartphone may be notified when the user merely approaches the store, or the notification message may be different depending on the distance from the store. For example, in a case where it is 50 m from the store (or if it is not detected to be in the vicinity of the store), it may be simply notified that they are on sale, or of information focusing on the main points such as the price of a featured product, whereas in a case where it is as close as 10 m from the store, more detailed information as illustrated in FIG. 6B may be notified.

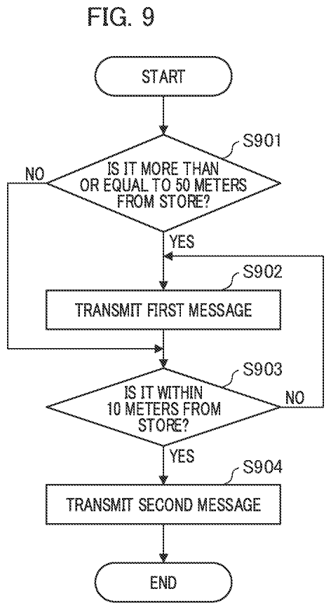

FIG. 9 is a flow chart illustrating an example of processing in the transmitter 800. In S901, the transmitter 800 determines whether or not the user's smartphone is farther than or equal to 50 m from the store. For this determination, for example, position information output by the global positioning system (GPS) function of the smartphone may be used. If the distance from the store is greater than or equal to 50 m (Yes), the transmitter 800 transmits, to the user's smartphone as a first message, for example information focusing on the main points such as that they are on sale or the price of a featured product (S902). On the other hand, if the distance from the store is not greater than or equal to 50 m (No in S901), the transmitter 800 determines whether or not the user's smartphone is within 10 m from the store in S903 and detects whether or not the user's smartphone is close to the store. If the distance from the store is less than 10 m (Yes), the transmitter 800 transmits, as a second message, more detailed information than the first message to the user's smartphone, for example as illustrated in FIG. 6B (S904). On the other hand, if the distance from the store is not less than 10 m (No in S903), the flow returns to S902, and the transmitter 800 transmits the first message to the user's smartphone.

As described above, according to the present embodiment, it is possible to facilitate a user to designate a product of which sales a store intends to promote.

The embodiment can also be realized by a computer of a system or apparatus (or devices such as a CPU or MPU) that reads out and executes a program recorded on a memory device to perform the functions of the above-described embodiment(s), and by a method, the steps of which are performed a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the embodiment of the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present application claims priority to Japanese Application No. 2019-237040, filed Dec. 26, 2019. The aforementioned application is hereby incorporated by reference herein.

What is claimed is:

1. A display device configured to display position information of a product on a basis of identification information of the product, the identification information being information of each product, and position information of a tag from which the identification information has been read, the display device comprising:
an acceptance unit configured to accept designation of a product from a user;
an acquisition unit configured to acquire position information associated with identification information of the product, designation of which by the user has been accepted by the acceptance unit, and scan time information indicating time when a tag as a basis of the position information has been read; and
a display control unit configured to display a floor map and a position corresponding to the position information acquired by the acquisition unit on the floor map in an identifiable manner in accordance with designation from the user, wherein
the display control unit makes display forms of the position information different depending on the scan time information.

2. The display device according to claim 1, wherein
the acquisition unit acquires inventory information of the designated product, and
the display control unit displays a notification when stocks of the designated product is less than or equal to a threshold value.

3. The display device according to claim 1, wherein
the display device is a signage device installed in a store, and
the display control unit displays an installation position of the signage device on the floor map in an identifiable manner.

4. The display device according to claim 1, wherein
the display device is a mobile terminal, and
the acceptance unit accepts designation of the product by photographing the tag with a camera included in the mobile terminal.

5. The display device according to claim 1, wherein
the display device is a mobile terminal, and
the acceptance unit accepts designation of the product by the user selecting the product in an advertisement delivered to the mobile terminal.

6. A mobile terminal configured to display position information of a product on a basis of identification information of each product and position information of a tag from which information corresponding to the identification information has been read, the mobile terminal comprising:
a reception unit configured to receive a message transmitted from outside on a basis of detection of approach to a store by a device;
an acceptance unit configured to accept designation of one or more products from a plurality of products included in the message; and
a display unit configured to display a floor map displaying a position of the product, designation of which by a user has been accepted by the acceptance unit, in an identifiable manner, wherein
the display unit makes display forms of the position information different depending on scan time information indicating time when a tag as a basis of position information of the product, designation of which by the user has been accepted, has been read.

7. A control method of a display device configured to display position information of a product on a basis of identification information of the product, the identification information being information of each product, and position information of a tag from which the identification information has been read, the control method comprising:
an acceptance step of accepting designation of a product from a user;
an acquisition step of acquiring position information associated with identification information of the product, designation of which by the user has been accepted in the acceptance step, and scan time information indicating time when a tag as a basis of the position information has been read; and
a display step of displaying a floor map and a position corresponding to the position information acquired in the acquisition step on the floor map in an identifiable manner in accordance with designation from the user, wherein
display forms of the position information are made different depending on the scan time information in the display step.

8. A non-transitory computer readable storage medium that stores a program for causing a computer to execute the control method of the display device according to claim 7.

9. A control method of a mobile terminal configured to display position information of a product on a basis of identification information of each product and position information of a tag from which information corresponding to the identification information has been read, the control method comprising:
a reception step of receiving a message transmitted from outside on a basis of detection of approach to a store by a device;
an acceptance step of displaying a plurality of products included in the message and accepting designation of one or more products from the plurality of displayed products; and
a display step of displaying a floor map displaying a position of the product, designation of which by a user has been accepted in the acceptance step, in an identifiable manner, wherein
display forms of the position information are made different depending on scan time information indicating time when a tag as a basis of position information of the product, designation of which by the user has been accepted, has been read in the display step.

10. A control method of a reading device configured to acquire identification information of a product, the identification information being information of each product, the control method comprising:
a first step of scanning a floor of a store by a reading unit of the reading device at a first frequency and acquiring identification information of a product displayed on the floor and information indicating time when the identification information was acquired;
a second step of acquiring identification information of a product displayed in an area by scanning the area that is narrower than in the first step at a second frequency that is higher than the first frequency and information indicating time when the identification information has been acquired; and
an update step of overwriting old information with recently read information when a same tag is read in the first step or the second step.

11. A guide system comprising: a server and a display device, wherein
the server comprises:
an acquisition unit configured to acquire identification information of each product read from a tag attached to each product by a reading device, information of a fixture in which the product is displayed in a store, and scan information indicating time when the identification information has been read;
an estimation unit configured to estimate position information of the tag from which the identification information has been acquired on a basis of the information of the fixture; and
an output unit configured to output the identification information acquired by the acquisition unit and the position information estimated by the estimation unit and the scan information in association with each other, and
the display device comprises:
an acceptance unit configured to accept designation of a product from a user;
a reception unit configured to receive position information associated with identification information of the product, designation of which by the user has been accepted by the acceptance unit; and
a display control unit configured to display a floor map, a position corresponding to the position information received by the reception unit on the floor map, and how recent the position information is in an identifiable manner in accordance with designation from the user.
